(19) United States
(12) Patent Application Publication
(10) Pub. No.: US 2026/0011744 A1
(43) Pub. Date: Jan. 8, 2026

(54) COMPOSITE COATING FOR CATHODE ACTIVE MATERIALS, AND SOLID-STATE CELL MADE THEREOF

(71) Applicant: Solid Power Operating, Inc., Louisville, CO (US)

(72) Inventors: Megan M. WEBSTER, Denver, CO (US); Alexandra BOTHWELL, Boulder, CO (US); Ayana WEST, Denver, CO (US); Jason E. ROBERTS, Denver, CO (US); Collin R. BECKER, Boulder, CO (US)

(21) Appl. No.: 19/263,239

(22) Filed: Jul. 8, 2025

Related U.S. Application Data
(60) Provisional application No. 63/668,736, filed on Jul. 8, 2024.

(51) Int. Cl. H01M 4/62; C01G 53/50; H01M 4/36; H01M 10/052; H01M 10/0562; H01M 10/058; H01M 50/431

(52) U.S. Cl. CPC H01M 4/628; C01G 53/50; H01M 4/366; H01M 10/052; H01M 10/0562; H01M 10/058; H01M 50/431; C01P 2002/50; C01P 2002/72; C01P 2004/03; C01P 2004/80; C01P 2006/40; H01M 2300/0068

(57) ABSTRACT

Coated cathode active materials include a cathode active material particle and a composite coating layer disposed on a surface of the cathode active material particle. The composite coating layer includes a carbonate material and a hydroxide material, and the carbonate material is disposed on a surface of the hydroxide material. The coated cathode active materials are incorporated into solid-state electrochemical cells.

### CROSS-REFERENCE TO RELATED APPLICATION

This application is related to and claims priority under 35 U.S.C. § 119 from U.S. Provisional Application No. 63/668,736 filed Jul. 8, 2024, titled “Composite Coating for Cathode Active Materials, and Solid State Cell Made thereof,” the entire contents of which are fully incorporated by reference herein for all purposes.

### TECHNICAL FIELD

The present disclosure relates to coated cathode active materials for use in electrochemical cells. Accordingly, the disclosure relates to the fields of batteries, including solid-state batteries, electronics, chemistry, and materials science.

### BACKGROUND

When selecting a battery technology for use in a specific application, characteristics that may be important include charging speed, power density, energy density, and cycle life. One of the factors that affects these characteristics is the type and amount of cathode active material (CAM) that is contained within the electrochemical cell. A type of cathode active material that has drawn much attention from various industries is the nickel-manganese-cobalt (NMC) variety of cathode active materials due to their ability to store large amounts of energy.

While these NMC materials may store large amounts of energy, they are less stable than other CAMs such as LiFePO₄ (LFP) type material. The NMC materials are less stable because they degrade over time causing a short cycle life for the electrochemical cell. The degradation of the NMC material may be even more severe when in contact with sulfide solid electrolyte materials where the NMC active materials may react with the sulfide solid electrolyte materials to form metal sulfides. To prevent this degradation, a ceramic coating may be applied to the surface of the NMC material where the ceramic coating material is stable against both the NMC material and the sulfide solid electrolytes. However, most conventional materials used to coat the NMC are expensive, use expensive coating techniques, have poor adhesion to the surface of the NMC material, and/or provide poor electrochemical stability. Accordingly, there is a need for methods and materials which can be used to increase the stability of NMC CAMs in an economic and efficient fashion, among other things.

### BRIEF SUMMARY

Aspects of the present disclosure involve a composite that, when used to coat NMC cathode active materials, provides superior electrochemical stability against sulfide electrolytes. The composite may also provide relatively higher adhesion, compared to other techniques, to the surface of the NMC. Further, the disclosed composite can be coated using inexpensive techniques. Additionally, the present application discloses a structurally stable coated NMC cathode active material having high capacity in combination with superior stability and cycle life characteristics. These and other advantages, alone or in combination, are provided by the novel composite as well as other aspects of the present disclosure.

### BRIEF DESCRIPTION OF THE DRAWINGS

FIG. 1 shows SEM images of uncoated NMC particles (left) vs. NMC particles coated with the composite cathode layer as described in Example 1 (right).

FIG. 2 shows an X-Ray Diffraction (XRD) pattern of the coated cathode active material of Example 1, and of Li₂O, LiOH and Li₂CO₃ .

FIG. 3 shows cycling data for the electrochemical cells produced in Examples 1 and 2.

FIG. 4 shows cycling data for the electrochemical cells produced in Examples 1 and 3.

### DETAILED DESCRIPTION

The present disclosure is directed to a composite material that, when used to coat an NMC cathode active material, allows for an increased cycle life of a solid-state electrochemical cell, among other advantages. Specifically and in one example, a composite material containing a hydroxide component and a carbonate component allows for formation of a stable interface between the NMC material and a sulfide based solid electrolyte material, when coated on the NMC active material. Accordingly, aspects of the present disclosure also provide a coated NMC cathode active material having strong adhesion between the coating and active material, high capacity, and strong stability and cycle life properties.

Before further details of various aspects are disclosed and described, it is to be understood that this invention is not limited to the particular methods, compositions, or materials disclosed herein, but is extended to equivalents thereof as would be recognized by those ordinarily skilled in the relevant arts. It should also be understood that terminology employed herein is used for the purpose of describing particular embodiments (aspects, examples, and the like) only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity and in another example, a numerical range of “about 50 mg/mL to about 80 mg/mL” should also be understood to provide support for the range of “50 mg/mL to 80 mg/mL.”

In this disclosure, the terms “including,” “containing,” and/or “having” are understood to mean comprising, and are open ended terms.

The indefinite articles “a” and “an,” as used herein in the specification and in the claims, unless clearly indicated to the contrary, should be understood to mean “at least one.”

As used herein, “aspect ratio” means the ratio of length to width, where length refers to the longest dimension of an object and width refers to the shortest dimension of the same object.

As used herein, an “NMC” or “NCM type” active material means an active material containing at least nickel, cobalt, and manganese.

### Coating Composition and Structure, and Coated Active Material

The composite material may be coated on a surface of NMC active material particles so as to form a composite coating layer on at least a portion of the surface of the CAM particles. The composite coating layer may have a structure in which the hydroxide material includes a morphology similar to needles, planar flakes, sphere-like particles, or a combination thereof, and where the carbonate material is present as a coating on the surface of the hydroxide material. When the hydroxide material has a needle-like morphology, the length of the needles may be from about 10 nm to about 2000 nm, and the width of the needles may be from about 1 nm to about 600 nm. The aspect ratio of the needles may be from about 2 to about 40. The hydroxide component of the coating may be at least partially coated with a layer of the carbonate material. In a preferred embodiment, the hydroxide material is fully coated or fully covered by a layer of the carbonate material. This layer of carbonate material helps to prevent the hydroxide component from reacting with electrolytes, cathode active materials, and/or processing solvents.

When the hydroxide material has a needle-like morphology, the length of the needles may be from about 10 nm to about 2000 nm, such as from about 10 nm to about 50 nm, about 10 nm to about 100 nm, about 10 nm to about 200 nm, about 10 nm to about 500 nm, about 10 nm to about 1000 nm, about 10 nm to about 1500 nm, about 10 nm to about 2000 nm, about 50 nm to about 2000 nm, about 100 nm to about 2000 nm, about 200 nm to about 2000 nm, about 500 nm to about 2000 nm, about 1000 nm to about 2000 nm, about 1500 nm to about 2000 nm, about 100 nm to about 1000 nm, or about 500 nm to about 1500 nm. As another example, the length of the needles may be about 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, 1000 nm, 1100 nm, 1200 nm, 1300 nm, 1400 nm, 1500 nm, 1600 nm, 1700 nm, 1800 nm, 1900 nm, or about 2000 nm. In an example, the length of the needles is from about 10 nm to about 40 nm. In another example, the length of the needles is from about 200 nm to about 2000 nm.

When the hydroxide material has a needle-like morphology, the width of the needles may be from about 1 nm to about 600 nm, such as from about 1 nm to about 5 nm, about 1 nm to about 10 nm, about 1 nm to about 25 nm, about 1 nm to about 50 nm, about 1 nm to about 100 nm, about 1 nm to about 200 nm, about 1 nm to about 400 nm, about 1 nm to about 600 nm, about 5 nm to about 600 nm, about 10 nm to about 600 nm, about 25 nm to about 600 nm, about 50 nm to about 600 nm, about 100 nm to about 600 nm, about 200 nm to about 600 nm, about 400 nm to about 600 nm, about 100 nm to about 400 nm, or about 100 nm to about 200 nm. As another example, the width of the needles may be about 1 nm, 2 nm, 3 nm, 4 nm, 5 nm, 6 nm, 7 nm, 8 nm, 9 nm, 10 nm, 15 nm, 20 nm, 25 nm, 30 nm, 35 nm, 40 nm, 45 nm, 50 nm, 60 nm, 70 nm, 80 nm, 90 nm, 100 nm, 150 nm, 200 nm, 250 nm, 300 nm, 350 nm, 400 nm, 450 nm, 500 nm, 550 nm, or about 600 nm. In an example, the width of the needles is from about 1 nm to about 5 nm. In another example, the width of the needles is from about 100 nm to about 600 nm.

When the hydroxide material has a needle-like morphology, the aspect ratio may be from about 2 to about 40, such as from about 2 to about 4, about 2 to about 6, about 2 to about 8, about 2 to about 10, about 2 to about 20, about 2 to about 30, about 2 to about 40, about 4 to about 40, about 6 to about 40, about 8 to about 40, about 10 to about 40, about 20 to about 40, or about 30 to about 40. As another example, the aspect ratio may be about 2, 3, 4, 5, 6, 7, 8, 9, 10, 15, 20, 25, 30, 35, or about 40. In one example, the aspect ratio is from about 2 to about 3. In another example, the aspect ratio is from about 2 to about 20.

The hydroxide material may include an alkali metal hydroxide or an alkaline earth metal hydroxide. In some cases, the hydroxide material may include Li, Na, K, Ca, Mg, or any combination thereof. For example, the hydroxide material may include LiOH, NaOH, KOH, Ca(OH)₂, Mg(OH)₂, or any combination thereof.

The carbonate material may include an alkali metal carbonate or an alkaline earth metal carbonate. In some cases, the carbonate material may include Li, Na, K, Ca, Mg, or any combination thereof. For example, carbonate hydroxide material may include Li₂CO₃, Na₂CO₃, K₂CO₃, CaCO₃, MgCO₃, or any combination thereof.

The ratio of hydroxide material to carbonate material in the composite coating layer may be from about 90 wt % hydroxide to about 10 wt % carbonate, such as from about 80 wt % hydroxide to about 20 wt % carbonate, or from about 70 wt % hydroxide to about 30 wt % carbonate.

The composite coating layer may have a porosity ranging from about 15% to about 50%, such as from about 20% to about 45%, or from about 25% to about 40%.

When coated onto the surface of a cathode active material particle, the thickness of the composite coating layer may be between about 100 nm and about 100 μm. The surface of the cathode active material may be fully or partially covered by the composite coating layer. When partially covered, the coverage may be about 99% or less to about 5% or more. The thickness of this coating on a cathode active material may not be uniform and may range from 0, where the coating is not covering the cathode, to about 100 μm.

The thickness of the composite coating layer may be greater than about 100 nm. In some applications, the thickness of the coating may be less than about 50 μm. In some embodiments, the thickness of the composite coating layer may be between about 300 nm and about 40 μm, or more preferably between about 500 nm and about 30 μm.

The cathode active material may comprise nickel, manganese, cobalt, aluminum, oxygen, lithium, or any combination thereof. In some aspects, the cathode active material may be an NMC material including at least nickel, manganese, and cobalt, which can be expressed as, e.g., Li(NiₐCo_{b}Mn_{c})O₂ (0<a<1, 0<b<1, 0<c<1, a+b+c=1), NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂), or a combination thereof. In another case, the cathode active material may comprise LiCoO₂, LiNiO₂, LiMnO₂, LiMn₂O₄, LiNi_{1-Y}Co_{Y}O₂, LiCo_{1-Y}Mn_{Y}O₂, LiNi_{1-Y}Mn_{Y}O₂(0≤Y<1), Li(NiₐCo_{b}Mn_{c})O₄ (0<a<2, 0<b<2, 0<c<2, a+b+c=2), LiMn_{2-Z}Ni_{Z}O₄, LiMn_{2-Z}Co_{Z}O₄(0<Z<2), LiCoPO₄, Li(NiₐCo_{b}Al_{c})O₂ (0<a<1, 0<b<1, 0<c<1, a+b+c=1) or a combination thereof.

In some cases, the coated cathode active material used in the coating process may already have a coating layer applied to its surface which is present in conjunction with and/or beneath the hydroxide-carbonate coating layer. This additional coating layer may be referred to as a first coating. This first coating may comprise Li, Zr, Al, Nb, Ti, C, or a combination thereof. The thickness of this first coating may range from about 50 nm to about 50 μm. This first coating may fully or partially cover the surface of the cathode active material and may lie beneath the hydroxide-carbonate coating layer (i.e. be interposed between the active material surface and the hydroxide-carbonate coating layer), may be mixed with the hydroxide-carbonate coating layer, and/or may be present in areas of the surface of the CAM which is not coated with the hydroxide-carbonate coating layer.

### Forming and Applying the Coating

A starting material including at least one alkali metal component, at least one alkaline earth metal component, or a combination thereof is placed in one or more solvents for a period of time such that a solution containing at least one alkali metal alkoxide, at least one alkaline earth metal alkoxide, or a combination thereof is formed. The at least one alkali metal alkoxide, the at least one alkaline earth metal alkoxide, or a combination thereof may form upon addition of the one or more solvents. The resulting solution may be brought into contact with one or more cathode active materials to form a mixture. A hydrogen-containing material is then introduced into the mixture.

After a period of time, the solvent may be removed from the mixture via a drying process. The dried material is then heat treated by heating it to an elevated temperature and flowing a gas over the heated material to form the disclosed coated active material. Once the heat treatment is complete, the disclosed hydroxide-carbonate coating layer may be present on at least a portion of the surface of the cathode active material.

The alkali metal component may comprise a lithium metal; a sodium metal; a potassium metal; a lithium metal alloy such as Li—Na, Li—K, Li—Mg, Li—Ca, Li—Al, and/or Li—Zr; LiOH; NaOH; lithium methoxide; lithium ethoxide; another lithium alkoxide material; sodium methoxide; sodium ethoxide; another sodium alkoxide material; or any combination thereof.

The alkaline earth metal component may comprise calcium metal, calcium metal alloys, magnesium metal, magnesium metal alloys, calcium hydroxide, magnesium hydroxide, calcium methoxide, calcium ethoxide, calcium alkoxide material, magnesium methoxide, magnesium ethoxide, magnesium alkoxide material, or any combination thereof.

The solvent may include one an alcohol, a hydrocarbon, or any combination thereof. The alcohol solvent may comprise methanol, ethanol, butanol, propanol, pentanol, hexanol, heptanol, octanol, or any isomers thereof or combinations thereof. The hydrocarbon solvent may be an alkane containing 4 or more carbons, or in some embodiments, 4 to 20 carbons. For example, alkanes such as butane, pentane, hexane, heptane, octane, and/or nonane may be used. The alkane may be a straight chain or branched. In some cases, the hydrocarbon solvent may be cyclic and contain more than 4 carbons. In some examples, the hydrocarbon solvent may be aromatic. For example, the hydrocarbon solvent may include cyclopentane, cyclohexane, cycloheptane, xylenes, toluene, benzene, or a combination thereof.

The alkali metal component, the alkaline earth metal component, or the combination thereof is brought into contact with the solvent for a period of time sufficient to dissolve some or all of the materials into solution. In a preferred embodiment, the majority of the materials, or substantially all of the materials (i.e., greater than 95% of the solid materials), are dissolved. The period of time for partial or full dissolution may range from about 1 minute to about 24 hours. In some aspects, the period of time is from about 5 minutes to about 12 hours. In some embodiments, the period of time ranges from about 10 minutes to about 5 hours.

The weight ratio between the solvent and the alkali metal component, the alkaline earth metal component, or the combination thereof may be from about 0.01 wt % to about 1 wt %. For example, the weight ratio between the solvent and the alkali metal component, the alkaline earth metal component, or the combination thereof may be from about 0.01 wt % to about 0.05 wt %, about 0.01 wt % to about 0.1 wt %, about 0.01 wt % to about 0.5 wt %, about 0.01 wt % to about 1 wt %, about 0.05 wt % to about 1 wt %, about 0.1 wt % to about 1 wt %, about 0.5 wt % to about 1 wt %, or about 0.05 wt % to about 0.5 wt %. As another example, the weight ratio between the solvent and the alkali metal component, the alkaline earth metal component, or the combination thereof may be about 0.01 wt %, 0.02 wt %, 0.03 wt %, 0.04wt %, 0.05 wt %, 0.06 wt %, 0.07 wt %, 0.08 wt %, 0.09 wt %, 0.1 wt %, 0.2 wt %, 0.3 wt %, 0.4 wt %, 0.5 wt %, 0.6 wt %, 0.7 wt %, 0.8 wt %, 0.9 wt %, or about 1 wt %.

The weight ratio between the solvent and the alkali metal component may be from about 0.01 wt % to about 1 wt %. For example, the weight ratio between the solvent and the alkali metal component may be from about 0.01 wt % to about 0.05 wt %, about 0.01 wt % to about 0.1 wt %, about 0.01 wt % to about 0.5 wt %, about 0.01 wt % to about 1 wt %, about 0.05 wt % to about 1 wt %, about 0.1 wt % to about 1 wt %, about 0.5 wt % to about 1 wt %, or about 0.05 wt % to about 0.5 wt %. As another example, the weight ratio between the solvent and the alkali metal component may be about 0.01 wt %, 0.02 wt %, 0.03 wt %, 0.04 wt %, 0.05 wt %, 0.06 wt %, 0.07 wt %, 0.08 wt %, 0.09 wt %, 0.1 wt %, 0.2 wt %, 0.3 wt %, 0.4 wt %, 0.5 wt %, 0.6 wt %, 0.7 wt %, 0.8 wt %, 0.9 wt %, or about 1 wt %.

The weight ratio between the solvent and the alkaline earth metal component may be from about 0.01 wt % to about 1 wt %. For example, the weight ratio between the solvent and the alkaline earth metal component may be from about 0.01 wt % to about 0.05 wt %, about 0.01 wt % to about 0.1 wt %, about 0.01 wt % to about 0.5 wt %, about 0.01 wt % to about 1 wt %, about 0.05 wt % to about 1 wt %, about 0.1 wt % to about 1 wt %, about 0.5 wt % to about 1 wt %, or about 0.05 wt % to about 0.5 wt %. As another example, the weight ratio between the solvent and the alkaline earth metal component may be about 0.01 wt %, 0.02 wt %, 0.03 wt %, 0.04wt %, 0.05 wt %, 0.06 wt %, 0.07 wt %, 0.08 wt %, 0.09 wt %, 0.1 wt %, 0.2 wt %, 0.3 wt %, 0.4 wt %, 0.5 wt %, 0.6 wt %, 0.7 wt %, 0.8 wt %, 0.9 wt %, or about 1 wt %.

The alkali metal alkoxide that forms in solution may comprise lithium methoxide, lithium ethoxide, or any other lithium alkoxide or combination thereof.

The alkaline earth metal alkoxide that ends up in solution may comprise a magnesium alkoxide such as magnesium methoxide, magnesium ethoxide, or the like or any combination thereof. The alkaline earth metal alkoxide may comprise calcium alkoxide such as calcium methoxide, calcium ethoxide, or the like or any combination thereof.

The cathode active material may comprise nickel, manganese, cobalt, aluminum, oxygen, lithium, or any combination thereof. In some aspects, the cathode active material may be a NMC material comprising at least nickel, manganese, and cobalt which can be expressed as, e.g., Li(NiₐCo_{b}Mn_{c})O₂(0<a<1, 0<b<1, 0<c<1, a+b+c=1), NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂), or a combination thereof. In some aspects, the cathode active material may comprise LiCoO₂, LiNiO₂, LiMnO₂, LiMn₂O₄, LiNi_{1-Y}Co_{Y}O₂, LiCo_{1-Y}Mn_{Y}O₂, LiNi_{1-Y}Mn_{Y}O₂(0≤Y<1), Li(NiₐCo_{b}Mn_{c})O₄ (0<a<2, 0<b<2, 0<c<2, a+b+c=2), LiMn_{2-Z}Ni_{Z}O₄, LiMn_{2-Z}Co_{Z}O₄(0<Z<2), LiCoPO₄, Li(NiₐCo_{b}Al_{c})O₂(0<a<1, 0<b<1, 0<c<1, a+b+c=1), or a combination thereof.

The hydrogen-containing material that is introduced into the mixture may comprise water, hydrogen peroxide, hydrogen gas, or a combination thereof. Upon addition of the hydrogen-containing material, the alkali metal alkoxide or the alkaline earth metal alkoxide may be converted to an alkali metal hydroxide or an alkaline earth metal hydroxide. For example, if the solution comprises an alkali metal alkoxide such as lithium ethoxide, the addition of the hydrogen-containing material may convert the lithium ethoxide to lithium hydroxide. In such embodiments, the final cathode active material may be substantially free (e.g., 1 wt % or less) of the alkali metal alkoxide or the alkaline earth metal alkoxide.

The weight ratio between the hydrogen-containing material and the alkali metal component, the alkaline earth metal component, or combination thereof may be within the range of 1:10 to 1:60. For example, the weight ratio between the hydrogen-containing material and the alkali metal component, the alkaline earth metal component, or combination thereof may be from about 1:10 to about 1:20, about 1:10 to about 1:30, about 1:10 to about 1:40, about 1:10 to about 1:50, about 1:10 to about 1:60, about 1:20 to about 1:60, about 1:30 to about 1:60, about 1:40 to about 1:60, about 1:40 to about 1:60, about 1:50 to about 1:60, about 1:20 to about 1:50, or about 1:30 to about 1:40. As another example, the weight ratio between the hydrogen-containing material and the alkali metal component, the alkaline earth metal component, or combination thereof may be about 1:10, 1:15, 1:20, 1:25, 1:30, 1:35, 1:40, 1:45, 1:50, 1:55, or about 1:60.

The weight ratio between the hydrogen-containing material and the alkali metal component may be within the range of 1:10 to 1:60. For example, the weight ratio between the hydrogen-containing material and the alkali metal component may be from about 1:10 to about 1:20, about 1:10 to about 1:30, about 1:10 to about 1:40, about 1:10 to about 1:50, about 1:10 to about 1:60, about 1:20 to about 1:60, about 1:30 to about 1:60, about 1:40 to about 1:60,about 1:40 to about 1:60, about 1:50 to about 1:60, about 1:20 to about 1:50, or about 1:30 to about 1:40. As another example, the weight ratio between the hydrogen-containing material and the alkali metal component may be about 1:10, 1:15, 1:20, 1:25, 1:30, 1:35, 1:40, 1:45, 1:50, 1:55, or about 1:60.

The weight ratio between the hydrogen-containing material and the alkaline earth metal component may be within the range of 1:10 to 1:60. For example, the weight ratio between the hydrogen-containing material and the alkaline earth metal component may be from about 1:10 to about 1:20, about 1:10 to about 1:30, about 1:10 to about 1:40, about 1:10 to about 1:50, about 1:10 to about 1:60, about 1:20 to about 1:60, about 1:30 to about 1:60, about 1:40 to about 1:60, about 1:40 to about 1:60, about 1:50 to about 1:60, about 1:20 to about 1:50, or about 1:30 to about 1:40. As another example, the weight ratio between the hydrogen-containing material and the alkaline earth metal component may be about 1:10, 1:15, 1:20, 1:25, 1:30, 1:35, 1:40, 1:45, 1:50, 1:55, or about 1:60.

The solvent may be removed by evaporation using known techniques. The solvent removal process may be referred to herein as a “drying” or a “drying process.”

Once the solvent had been sufficiently removed, the cathode active material may be heat treated by heating to a temperature ranging from about 100° C. to about 500° C. and maintained at a temperature within that range for a period of time ranging from about 1 minute to about 24 hours. For example, the temperature may range from about 100° C. to about 200° C., about 100° C. to about 300° C., about 100° C. to about 400° C., about 100° C. to about 500° C., about 200° C. to about 500° C., about 300° C. to about 500° C., about 400° C. to about 500° C., about 200° C. to about 300° C., about 200° C. to about 400° C., or about 300° C. to about 400° C. As another example, the temperature may be about 100° C., 125° C., 150° C., 175° C., 200° C., 225° C., 250° C., 275° C., 300° C., 325° C., 350° C., 375° C., 400° C., 425° C., 450° C., 475° C., or about 500° C.

During this heat treatment process, a gas or blend of gases may be passed over the cathode active material particles. This gas or gas blend may comprise nitrogen, argon, oxygen, hydrogen, carbon dioxide, carbon monoxide, water vapor, hydrogen peroxide vapor, or any combination thereof. In some embodiments, the gas may be dry air. The dry air may be, e.g., ultra zero grade air. The dry air may have a water vapor content of less than 100 ppm, or less than 10 ppm.

### Electrochemical Cell Containing the Coated Cathode Active Material

Further provided herein is a solid-state electrochemical cell comprising an anode layer, a cathode layer, and a solid-state electrolyte layer (i.e., a separator layer). The solid-state electrolyte layer is disposed between the anode layer and the cathode layer. In some embodiments, the solid-state electrochemical cell further comprises a first current collector layer and a second current collector layer, wherein the first current collector layer is disposed adjacent to the anode layer and the second current collector layer is disposed adjacent to the cathode layer.

Preferably, the anode layer of the electrochemical cell comprises one or more anode active materials containing lithium metal, lithium alloys, silicon, silicon alloys, graphite, carbon, tin, or any combination thereof.

The anode layer may include an anode active material, a conductive additive, a solid electrolyte material, a binder, or any combination thereof. In some embodiments, the anode layer may include an anode active material, optionally a conductive additive, optionally a solid electrolyte material, and optionally a binder.

The anode active material in the anode layer may comprise Silicon (Si), Tin (Sn), Germanium (Ge), graphite, Li₄Ti₅O₁₂ (LTO), lithium metal, lithium metal alloy, or other known anode active materials or any combination thereof.

The anode active material may be present in the anode layer in an amount from about 30% to about 100% by weight. In some aspects, the electrode active material may be present in the anode layer in an amount of about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 30% to about 80%, about 30% to about 85%, about 30% to about 90%, about 30% to about 95%, about 35% to about 100%, about 40% to about 100%, about 45% to about 100%, about 50% to about 100%, about 55% to about 100%, about 60% to about 100%, about 65% to about 100%, about 70% to about 100%, about 75% to about 100%, about 80% to about 100%, about 100% to about 100%, about 90% to about 100%, about 40% to about 90%, about 40% to about 80%, about 40% to about 70%, about 40% to about 60%, about 40% to about 55%, about 40% to about 50%, or about 40% to about 45% by weight.

The anode active material may have an average particle size from about 0.5 microns to about 50 microns, such as from about 0.5 microns to about 1 micron, about 0.5 microns to about 10 microns, about 0.5 microns to about 20 microns, about 0.5 microns to about 30 microns, about 0.5 microns to about 40 microns, about 0.5 microns to about 0.5 microns, about 1 micron to about 50 microns, about 10 microns to about 50 microns, about 20 microns to about 50 microns, about 30 microns to about 50 microns, or about 40 microns to about 50 microns.

The conductive additive may include carbon fiber, graphite, graphene, carbon black, conductive carbon, amorphous carbon, vapor grown carbon fiber (VGCF), activated carbon, carbon nanotubes, or any combination thereof.

The conductive additive may be present in the anode layer in an amount of about 1% to about 20% by weight of the anode layer. In various embodiments, the conductive additive may be present in the anode layer in an amount of about 1% to about 20% by weight, about 1% to about 15% by weight, about 1% to about 12% by weight, or about 1% to about 10% by weight. In some embodiments, the conductive additive may be present in an amount of about 1%, 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, 9.5%, 10.0%, 10.5%, 11.0%, 11.5%, 12.0%, 12.5%, 13.0%, 13.5%, 14.0%, 14.5%, 15.0%, 15.5%, 16.0%, 16.5%, 17.0%, 17.5%, 18.0%, 18.5%, 19.0%, 19.5%, or about 20.0% by weight of the anode layer.

The average particle size of the conductive additive may be from about 5 nm to about 1000 nm. In some aspects, the average particle size of the conductive additive may be about from 5 nm to about 100 nm, about 5 nm to about 200 nm, about 5 nm to about 300 nm, about 5 nm to about 400 nm, about 5 nm to about 500 nm, about 5 nm to about 600 nm, about 5 nm to about 700 nm, about 5 nm to about 800 nm, about 5 nm to about 900 nm, about 100 nm to about 1000 nm, about 200 nm to about 1000 nm, about 300 nm to about 1000 nm, about 400 nm to about 1000 nm, about 500 nm to about 1000 nm, about 600 nm to about 1000 nm, about 700 nm to about 1000 nm, about 800 nm to about 1000 nm, about 900 nm to about 1000 nm, about 100 nm to about 500 nm, or about 200 nm to about 400 nm. In some embodiments, the conductive additive may have a particle size of about 5 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, or about 1000 nm.

The solid electrolyte material may comprise one or more material combinations such as Li₂S—P₂S₅, Li₂S—P₂S₅—LiI, Li₂S—P₂S₅—GeS₂, Li2_{S}—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, and Li₂S—S—SiS₂—LiₓMO_{y} (where x and y are positive numbers, and M is P, Si, Ge, B, Al, Ga or In).

The solid electrolyte material may include Li₃PS₄, Li₄P₂S₆, Li₇P₃S₁₁, Li₁₀GeP₂S₁₂, Li₁₀SnP₂S₁₂, or any combination thereof. In a further embodiment, the solid electrolyte may be an argyrodite electrolyte, such as Li₆PS₅Cl, Li₆PS₅Br, Li₆PS₅I or expressed by the formula Li_{7-y}PS_{6-y}X_{y} where “X” represents at least one halogen and/or at least one pseudo-halogen, and where 0<y≤ 2.0 and where the halogen may be one or more of F, Cl, Br, I, and the pseudo-halogen may be one or more of N, NH, NH₂, NO, NO₂, BF₄, BH₄, AlH₄, CN, and SCN, or any combination thereof. In yet another embodiment, the solid-state electrolyte material may be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, Cl, Br, I, and the pseudo-halogen may be one or more of N, NH, NH₂, NO, NO₂, BF₄, BH₄, AlH₄, CN, and SCN.

The solid electrolyte material may include a halide solid electrolyte. Halide solid electrolytes may have the structure Li-M-X, wherein Mis a metal element, and X is a halogen. These maybe expressed by the generic formula Lip_{α}M⁴⁺_{β}A³⁺_{(1-β)}X_{Ω}Y_{(6-Ω)}, where: 0≤β≤1; 0≤Ω≤6; α=6−[(β*4)+(1−β)*3]; X and Y are each independently a halogen such as F, Cl, Br, or I; M is an element with an oxidation state of 4⁺ such as Ti, Zr, Hf, or Rf, and A is an element an oxidation state of 3⁺ such as Ga, In, Tl, Sc, Y, Fe, Ru, Os, or Er. Examples of halide solid electrolytes include Li₂ZrCl₆, Li₃InCl₆, and Li_{2.25}Hf_{0.75}Fe_{0.25}Cl₄Br₂.

In general, the solid electrolyte may be present in the anode layer in an amount from about 0% to about 60% by weight of the anode layer. In various embodiments, the solid electrolyte may be present in the anode layer in an amount from about 0% to about 10% by weight, about 0% to about 20% by weight, about 0% to about 30% by weight, about 0% to about 40% by weight, about 0% to about 50% by weight, about 10% to about 60% by weight, about 20% to about 60% by weight, about 30% to about 60% by weight, about 40% to about 60% by weight, about 50% to about 60% by weight, about 10% to about 50% by weight, or about 20% to about 40% by weight. In some embodiments, the solid electrolyte material may be present in the anode layer in an amount of about 5%, 10%, 15%, 20%, 25%, 30%, 35%, 40%, 45%, 50%, 55%, or 60% by weight of the anode layer.

The solid electrolyte material may have an average particle size from about 0.5 microns to about 50 microns, such as from about 0.5 microns to about 1 micron, about 0.5 microns to about 10 microns, about 0.5 microns to about 20 microns, about 0.5 microns to about 30 microns, about 0.5 microns to about 40 microns, about 0.5 microns to about 0.5 microns, about 1 micron to about 50 microns, about 10 microns to about 50 microns, about 20 microns to about 50 microns, about 30 microns to about 50 microns, or about 40 microns to about 50 microns.

The binder may comprise one or more thermoplastic elastomer(s). Suitable non-limiting examples of thermoplastic elastomers include styrene-butadiene rubber (SBR), styrene-butadiene-styrene block copolymer (SBS), styrene-isoprene block copolymer (SIS), styrene-ethylene-butylene-styrene block copolymer (SEBS), polyacrylonitrile (PAN), nitrile-butylene rubber (NBR), polybutadiene, polyisoprene, poly (methacrylate) nitrile-butadiene rubber (PMMA-NBR) and the like. In an embodiment, the binder includes a styrene-ethylene-butylene-styrene block copolymer (SEBS).

Generally, the binder may be present in the anode layer in an amount from about 0% to about 40.0% by weight of the anode layer. In various embodiments, the binder may be present in the cathode composite in an amount from about 1.0% to about 40.0%, about 1.0% to about 10.0%, about 1.0% to about 15.0%, about 5.0% to about 20.0%, about 10.0% to about 20.0%, about 15.0% to about 20.0%, about 20.0% to about 25.0%, about 20.0% to about 30.0%, about 20.0% to about 35.0%, about 20.0% to about 40%, about 30.0% to about 35.0%, or about 30.0% to about 40.0%. In some embodiments, the binder may be present in the anode layer in an amount of about 0.0%, 1.0%, 2.0%, 3.0%, 4.0%, 5.0%, 6.0%, 7.0%, 8.0%, 9.0%, 10.0%, 15.0%, 20.0%, 25.0%, 30.0%, 35.0%, or about 40.0% by weight of the anode layer. In an embodiment, the binder is present in the anode layer in an amount from about 1% to about 5% by weight of the anode layer.

The cathode layer may comprise a cathode active material such as an NMC type cathode active material comprising at least nickel, manganese, and cobalt which can be expressed as, e.g., Li(NiₐCo_{b}Mn_{c})O₂(0<a<1, 0<b<1, 0<c<1, a+b+c=1), NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.5}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂), or a combination thereof. In some aspects, the cathode active material may comprise one or more of a coated or uncoated metal oxide, such as but not limited to V₂O₅, V₆O₁₃, MoO₃, LiCoO₂, LiNiO₂, LiMnO₂, LiMn₂O₄, LiNi_{1-Y}Co_{Y}O₂, LiCo_{1-Y}Mn_{Y}O₂, LiNi_{1-Y}Mn_{Y}O₂(0≤Y<1), Li(NiₐCo_{b}Mn_{c})O₄ (0<a<2, 0<b<2, 0<c<2, a+b+c=2), LiMn_{2-Z}Ni_{Z}O₄, LiMn_{2-Z}Co_{Z}O₄(0<Z<2), LiCoPO₄, LiFePO₄, CuO, or Li(NiₐCo_{b}Al_{c})O₂(0<a<1, 0<b<1, 0<c<1, a+b+c=1). In other embodiments, the cathode active material may comprise one or more of a coated or uncoated metal sulfide such as but not limited to titanium sulfide (TiS₂), molybdenum sulfide (MoS₂), iron sulfide (FeS, FeS₂), copper sulfide (CuS), or nickel sulfide (Ni₃S₂). In another embodiment, the cathode active material may comprise one or more of a metal fluoride, such as but not limited to iron fluoride (FeF₂, FeF₃), copper fluoride (CuF₂), zinc fluoride (ZnF₂), titanium fluoride (TiF₄), or nickel fluoride (NiF₂).

The cathode active material may be partially or fully coated with the hydroxide-carbonate composite coating layer of the present invention where a partial coating may be greater than 5% coverage to less than 100% coverage of the surface of the cathode active material. For example, a partial coating may have a coverage from about 5% to about 20%, about 5% to about 40%, about 5% to about 60%, about 5% to about 80%, about 5% to about 95%, about 5% to about 99%, about 20% to about 99%, about 40% to about 99%, about 60% to about 99%, about 80% to about 99%, about 95% to about 95%, or about 40% to about 80% of the surface of the cathode active material. As another example, a partial coating may have a coverage of about 5%, 10%, 15%, 20%, 25%, 30%, 35%, 40%, 45%, 50%, 55%, 60%, 65%, 70%, 75%, 80%, 85%, 90%, 95%, 96%, 97%, 98%, or about 99%.

The cathode layer may comprise one or more conductive additives. The conductive additives may include metal powders, fibers, filaments, or any other material known to conduct electrons. In some aspects, the one or more conductive additives may include one or more conductive carbon materials such as carbon fiber, graphite, graphene, carbon black, conductive carbon, amorphous carbon, VGCF, silicon-carbon composites, or carbon nanotubes. In some aspects, the conductive additive may be present in the cathode layer in an amount from about 1 wt % to about 10 wt %.

The cathode layer may comprise one or more solid-state electrolytes. The one or more solid-state electrolytes may comprise an oxide, oxysulfide, sulfide, halide, nitride, or any other solid-state electrolyte known in the art. In some preferred embodiments, the one or more solid-state electrolytes may comprise a sulfide solid-state electrolyte. In some embodiments, the solid-state electrolyte may comprise one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, or Li₂S—S—SiS₂—LiₓMO_{y} (where x and y are positive numbers, and M is P, Si, Ge, B, Al, Ga or In). In another embodiment, the solid-state electrolyte may be selected from the group consisting of one or more of a Li₃PS₄, Li₄P₂S₆, Li₇P₃S₁₁, Li₁₀GeP₂S₁₂, and Li₁₀SnP₂S₁₂. In a further embodiment, the solid-state electrolyte may be selected from the group consisting of one or more of a Li₆PS₅Cl, Li₆PS₅Br, and Li₆PS₅I or may expressed by the formula Li_{7-y}PS_{6-y}X_{y} where “X” represents at least one halogen and/or at least one pseudo-halogen, where 0<y≤2.0, and where the at least one halogen may be one or more of F, Cl, Br, I, and the at least one pseudo-halogen may be one or more of N, NH, NH₂, NO, NO₂, BF₄, BH₄, AlH₄, CN, or SCN. In yet another embodiment, the solid-state electrolyte may be expressed by the formula Li_{8-y-z}P₂S_{9-y-z}X_{y}W_{z} (where “X” and “W” represents at least one halogen elements and or pseudo-halogen and where 0≤y≤1 and 0≤z≤1) and where a halogen may be one or more of F, Cl, Br, I, and a pseudo-halogen may be one or N, NH, NH₂, NO, NO₂, BF₄, BH₄, AlH₄, CN, and SCN. In some aspects, the solid state electrolyte may be present in the cathode layer in an amount from about 5 wt % to about 20 wt %.

The cathode layer may comprise a binder. In some embodiments, the binder may include a fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, poly (methacrylate) nitrile-butadiene rubber (PMMA-NBR), and the like. In a further embodiment, the binder may be one or more of an acrylic resin such as but not limited to polymethyl (meth) acrylate, polyethyl (meth) acrylate, polyisopropyl (meth) acrylate polyisobutyl (meth) acrylate, polybutyl (meth) acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), ethylene propylene diene monomer rubber (EPDM), and mixtures thereof. In some aspects, the binder may be present in the cathode layer in an amount from about 0 wt % to about 5 wt %.

The solid-state electrolyte layer (also referred to herein as the “separator layer”) may comprise one or more solid-state electrolytes. The one or more solid-state electrolytes may comprise an oxide, oxysulfide, sulfide, halide, nitride, or any other solid-state electrolyte known in the art. In some preferred embodiments, the one or more solid-state electrolytes may comprise a sulfide solid-state electrolyte. In some aspects, the sulfide solid-state electrolyte may be an argyrodite material. In some aspects, the one or more sulfide solid-state electrolytes may comprise one or more material combinations such as Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—S—SiS₂—LiCl, Li₂S—S—SiS₂—B₂S₃—LiI, Li₂S—S—SiS₂—P₂S₅—LiI, Li₂S—B₂S₃, Li₂S—P₂S₅—ZₘSₙ (where m and n are positive numbers, and Z is Ge, Zn or Ga), Li₂S—GeS₂, Li₂S—S—SiS₂—Li₃PO₄, or Li₂S—S—SiS₂—LiₓMO_{y} (where x and y are positive numbers, and M is P, Si, Ge, B, Al, Ga or In). In some embodiments, one or more of the solid electrolyte materials may be Li₃PS₄, Li₄P₂S₆, Li₇P₃S₁₁, Li₁₀GeP₂S₁₂, Li₁₀SnP₂S₁₂, or combinations thereof. In another embodiment, one or more of the solid electrolyte materials may be Li₆PS₅Cl, Li₆PS₅Br, Li₆PS₅I or may be expressed by the formula Li_{7-y}PS_{6-y}X_{y}, where “X” represents at least one halogen and/or at least one pseudo-halogen, where 0<y≤2.0, and where the halogen may be one or more of F, Cl, Br, I, or combinations thereof, and the pseudo-halogen may be one or more of N, NH, NH₂, NO, NO₂, BF₄, BH₄, AlH₄, CN, SCN, or combinations thereof. In another embodiment, one or more of the solid electrolyte materials may be expressed by the formula Li_{8-y-z}P₂S_{9-y-z}X_{y}W_{z} (where “X” and “W” represents at least one halogen and/or at least one pseudo-halogen and where 0≤y≤1 and 0≤z≤1) and where the halogen may be one or more of F, Cl, Br, or I, and the pseudo-halogen may be one or more of N, NH, NH₂, NO, NO₂, BF₄, BH₄, AlH₄, CN, SCN, or combinations thereof.

The solid-state electrolyte layer may further comprise a binder. In some embodiments, the binder may include a fluororesin containing vinylidene fluoride (VdF), hexafluoropropylene (HFP), tetrafluoroethylene (TFE), or derivatives thereof as structural units. Specific examples thereof may include homopolymers such as polyvinylidene fluoride (PVdF), polyhexafluoropropylene (PHFP), and polytetrafluoroethylene (PTFE), and binary copolymers such as copolymers of VdF and HFP such as poly (vinylene difluoride-hexafluoropropylene) copolymer (PVdF-HFP), and the like. In another embodiment, the binder may be one or more of a thermoplastic elastomer, such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, poly (methacrylate) nitrile-butadiene rubber (PMMA-NBR) and the like. In a further embodiment, the binder may be one or more of an acrylic resin such as but not limited to polymethyl (meth) acrylate, polyethyl (meth) acrylate, polyisopropyl (meth) acrylate polyisobutyl (meth) acrylate, polybutyl (meth) acrylate, and the like. In yet another embodiment, the binder may be one or more of a polycondensation polymer such as but not limited to polyurea, polyamide paper, polyimide, polyester, and the like. In yet a further embodiment, the binder may be one or more of a nitrile rubber such as but not limited to acrylonitrile-butadiene rubber (ABR), polystyrene nitrile-butadiene rubber (PS-NBR), ethylene propylene diene monomer rubber (EPDM), and mixtures thereof. In some aspects, the binder may be present in the solid-state electrolyte layer in an amount from about 0% to about 20% by weight.

In some embodiments, the solid-state electrolyte layer may have a thickness from about 10 μm to about 40 μm. In some aspects, the solid-state electrolyte layer may have a thickness from about 10 μm to about 20 μm, about 10 μm to about 30 μm, about 20 μm to about 30 μm, about 20 μm to about 40 μm, or about 30 μm to about 40 μm. In some additional aspects, the solid-state electrolyte layer may have a thickness of about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, about 30 μm, about 31 μm, about 32 μm, about 33 μm, about 34 μm, about 35 μm, about 36 μm, about 37 μm, about 38 μm, about 39 μm, or about 40 μm.

The first current collector and the second current collector may comprise one or more of copper, aluminum, nickel, titanium, stainless steel, magnesium, iron, zinc, indium, germanium, silver, platinum, or gold. The current collector may further comprise a carbon coating adjacent to the anode layer or the cathode layer. In some embodiments, the first current collector or the second current collector may have a thickness from about 5 μm to about 10 μm. In preferred embodiments, the first current collector comprises copper, nickel, and/or steel.

### EXAMPLES

### Example 1—Cathode Coating

In a beaker, lithium metal was placed in ethanol where the weight ratio of lithium metal to alcohol was 1:337. This mixture was stirred for about 1 hour. Once the lithium metal was fully dissolved, an NMC cathode active material was added to the solution. The weight ratio between the cathode active material and the dissolved lithium was between 1:100 and 1:500. This mixture was stirred for about 30 minutes. After the stirring, water was added to the mixture where the weight ratio between the lithium and the water was 1:30. This mixture was allowed to stir for about 1 hour. The solution was then placed in a Roto Vap and tumbled under vacuum overnight at about 50° C. to remove the solvent. Once the powder was completely dried, the powder was transferred to a crucible and heated close to its crystallization temperature for a specific time with a specific flow rate of dry air. The resulting material was an NMC cathode active material comprising a hydroxide-carbonate coating. The coating included lithium hydroxide and lithium carbonate. No lithium ethoxide intermediate was present in the coating.

### Cathode Composite and Cathode Layer Formation

The coated cathode material was used to form a cathode composite which was used as the cathode layer of an electrochemical cell. The cathode composite was made by combining the coated NMC cathode active material with a carbon additive, and an argyrodite solid electrolyte material in a 67:2.5:30.5 weight ratio. The materials were then mixed with a mortar and pestle for several minutes to form the cathode composite.

### Solid State Cell Construction

A solid state electrochemical cell was constructed using the cathode composite as the cathode layer, an Argyrodite solid electrolyte material as the separator layer, and lithium metal foil as the anode layer. These layers were assembled such that the separator layer was disposed between the cathode layer and the anode layer forming a multi-layer stack. This stack was then compressed in a pressing machine to ensure optimal contact between the layers.

### Cell Cycling

The electrochemical cell of Example 1 was cycled with a voltage window between 2.5 and 4.2 volts. The temperature of the cell was 45° C. and the cell was compressed with a stack pressure of 1 MPa.

### Example 2—Comparative Example

The cathode composite of Example 2 was constructed in the same manner as that of Example 1, except the cathode active material used was an uncoated NMC material.

The uncoated cathode active material of Example 2 was used to form a cathode composite using the same material ratios and techniques as those described in Example 1.

The electrochemical cell of Example 2 was cycled under the same conditions as those described in Example 1.

### Example 3—Comparative Example

The cathode active material of Example 3 was coated with Li2CO3 by hand mixing an NMC material with Li₂CO3 powder where the weight ratio of this mixture was 99:1 NMC:Li₂CO₃.

The cathode composite of Example 3 was constructed the same as that of Example 1 except the cathode active material of Example 3 was used.

The coated cathode active material of Example 3 was used to form a cathode composite using the same material ratios and techniques as those described in Example 1.

The electrochemical cell of Example 3 was cycled under the same conditions as those described in Example 1.

### Analysis—Coating Properties

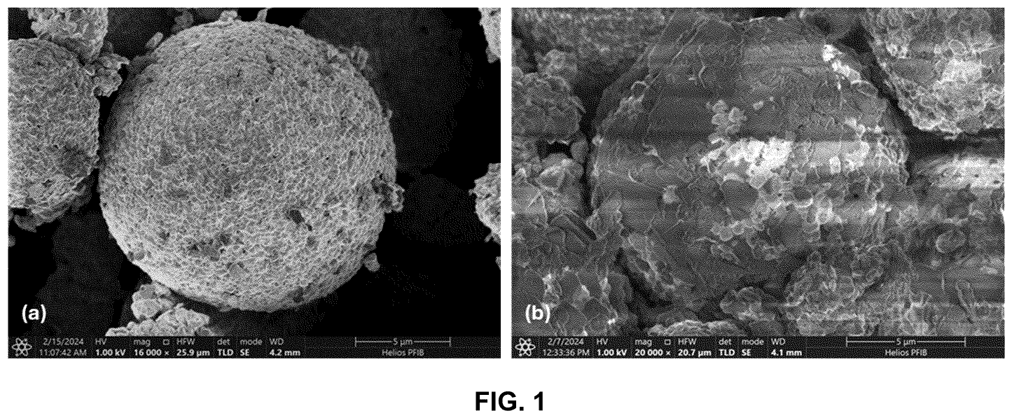

FIG. 1 shows an example of an uncoated cathode active material particle (left) and a coated cathode active material particle (right). As shown in FIG. 1, the composite coating layer has a morphology comprising needles, planar flakes, and sphere-like particles.

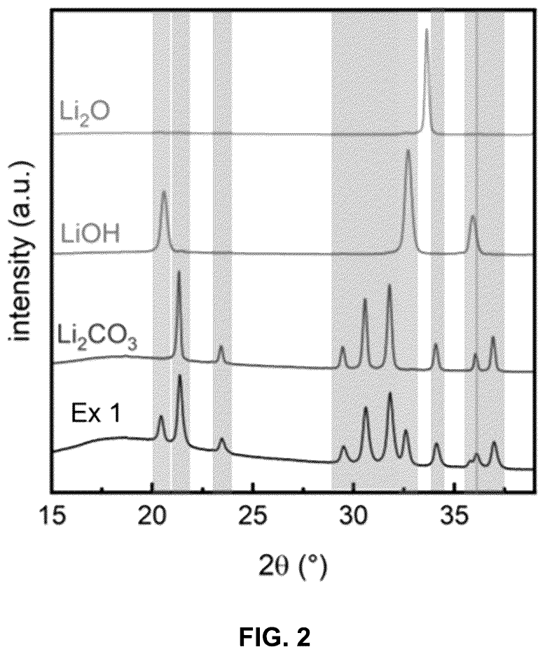

FIG. 2 shows an X-Ray Diffraction (XRD) pattern of the coated cathode active material of Example 1, and of Li₂O, LiOH and Li₂CO₃ . From FIG. 2, it can be seen that the coating produced in Example 1 contains both Li₂CO₃ and LiOH while being devoid of Li₂O.

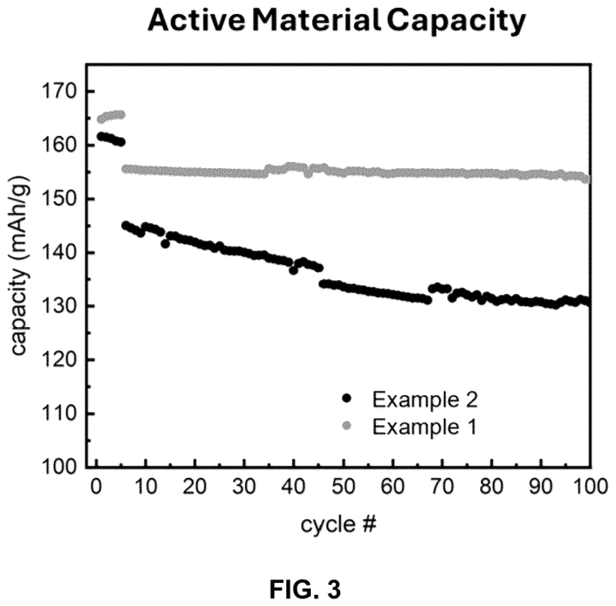

Comparing the cycling data of the electrochemical cell of Example 1 to that of the electrochemical cell of Example 2 as shown in FIG. 3, it can be seen that the cell of Example 1 has superior electrochemical stability as compared to the cell of Example 2. This surprising stability comes from the unique morphology of the LiOH and Li₂CO₃ containing coated layer on the surface of the cathode active material of Example 1.

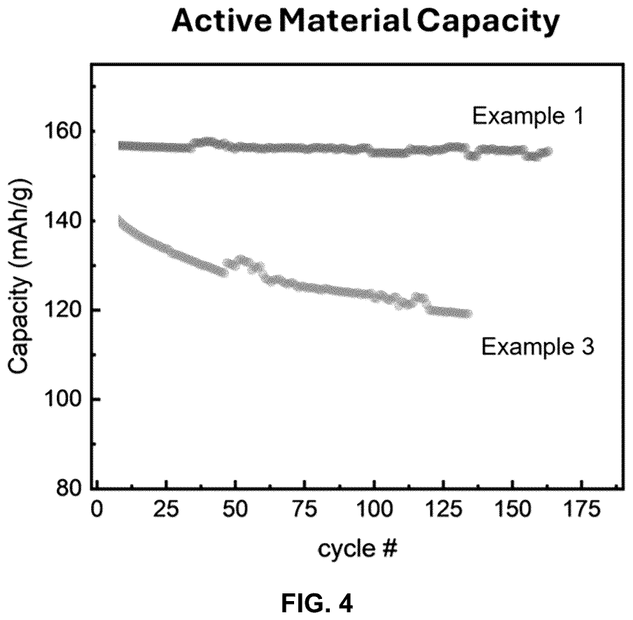

Comparing the cycling data of the electrochemical cell of Example 1 to that of the electrochemical cell of Example 3 as shown in FIG. 4, it can be seen that the cell of Example 1 has superior electrochemical stability as compared to the cell of Example 3. The cathode active material of Example 3 has a coating of pure lithium carbonate which should be electrochemically stable at the cell voltages used and should be chemical inert, thus, not reacting or decomposing when in contact with the sulfide solid electrolyte contained in the cathode composite and the separator layer. However, the data shows that this pure Li₂CO₃ coating provides little to no benefit over using NMC without a coating like in Example 2. The surprising stability of the coating produced in Example 1 arises not just from the stable components like Li₂CO₃ but in the unique morphology of the LiOH and Li₂CO₃ contained in the coating.

What is claimed is:

1. A coated cathode active material comprising:
a cathode active material particle; and
a composite coating layer disposed on a surface of the cathode active material particle, comprising a carbonate material and a hydroxide material,
wherein the carbonate material is disposed on a surface of the hydroxide material.

2. The coated cathode active material of claim 1, wherein the hydroxide material has a morphology comprising needles, planar flakes, sphere-like particles, or a combination thereof.

3. The coated cathode active material of claim 1, wherein the cathode active material particle comprises nickel, manganese, cobalt, aluminum, oxygen, lithium, or any combination thereof.

4. The coated cathode active material of claim 1, where the cathode active material particle comprises Li(NiₐCo_{b}Mn_{c})O₂, wherein 0<a<1, 0<b<1, 0<c<1, and a+b+c=1.

5. The coated cathode active material of claim 1, where the cathode active material particle comprises: LiCoO₂; LiNiO₂; LiMnO₂; LiMn₂O₄; LiNi_{1-Y}Co_{Y}O₂; LiCo_{1-Y}Mn_{Y}O₂; LiNi_{1-Y}Mn_{Y}O₂, wherein 0≤Y<1; Li(NiₐCo_{b}Mn_{c})O₄, wherein 0<a<2, 0<b<2, 0<c<2, and a+b+c=2; LiMn_{2-Z}Ni_{Z}O₄; LiMn_{2-Z}Co_{Z}O₄, wherein 0<Z<2; LiCoPO₄; Li(NiₐCo_{b}Al_{c})O₂, wherein 0<a<1, 0<b<1, 0<c<1, and a+b+c=1; or a combination thereof.

6. The coated cathode active material of claim 1, wherein a weight ratio between the hydroxide material and the carbonate material is from about 90 wt % hydroxide to about 10 wt % carbonate.

7. The coated cathode active material of claim 1, wherein the hydroxide material comprises Li, Na, K, Ca, or Mg.

8. The coated cathode active material of claim 1, wherein the carbonate material comprises Li, Na, K, Ca, or Mg.

9. The coated cathode active material of claim 2, wherein the hydroxide material has a needle-like morphology and a length of the needles is from about 10 nm to about 2000 nm.

10. The coated cathode active material of claim 2, wherein the hydroxide material has a needle-like morphology and a width of the needles is from about 1 nm to about 600 nm.

11. The coated cathode active material of claim 2, wherein the hydroxide material has a needle-like morphology and an aspect ratio of the needles is from about 2 to about 40.

12. The coated cathode active material of claim 1, wherein the entire surface of the hydroxide material is covered by the carbonate material.

13. The coated cathode active material of claim 1, wherein the composite coating layer has a porosity within a range of about 15% to about 50%.

14. The coated cathode active material of claim 1, wherein the composite coating layer has a thickness within a range of about 100 nm to about 100 μm.

15. The coated cathode active material of claim 1, wherein the entire surface of the cathode active material particle is covered by the composite coating layer.

16. The coated cathode active material of claim 1, wherein about 5% to about 99% of the surface of the cathode active material particle is covered by the composite coating layer.

17. The coated cathode active material of claim 1, further comprising a first coating comprising at least one of Li, Zr, Al, Nb, Ti, or carbon, disposed on the surface of the cathode active material particle.

18. The coated cathode active material of claim 17, wherein the first coating comprises at least one of Al₂O₃, ZrO₂, TiO₂, Nb₂O₅, LiNbO₃, LiAlO₂, or Li₂ZrO₃.

19. The coated cathode active material of claim 17, wherein the first coating has a thickness from about 50 nm to about 50 μm.

20. The coated cathode active material of claim 17, wherein the entire surface of the cathode active material particle is covered by the first coating, such that the first coating is interposed between the cathode active material particle and the composite coating layer.

21. An electrochemical cell comprising:
a cathode current collector, a cathode layer, a separator layer, an anode layer, and an anode current collector;
wherein the cathode layer comprises the coated cathode active material of claim 1.

22. The electrochemical cell of claim 21, wherein the cathode active material particle comprises Li(NiₐCo_{b}Mn_{c})O₂, wherein 0<a<1, 0<b<1, 0<c<1, and a+b+c=1.

23. The electrochemical cell of claim 21, wherein the separator layer comprises a sulfide solid electrolyte.

24. The electrochemical cell of claim 23, wherein the sulfide solid electrolyte comprises an argyrodite material.

25. The electrochemical cell of claim 21, wherein the anode layer comprises at least one of Li, Li alloy, Si, Si alloy, or carbon.

26. A method of making the coated cathode active material of claim 1, comprising:
adding a starting material comprising at least one of an alkali metal component or an alkaline earth metal component to a solvent to form a solution containing at least one of an alkali metal alkoxide or an alkaline earth metal alkoxide;
adding a cathode active material particle to the solution to form a mixture;
adding a hydrogen-containing material to the mixture;
removing the solvent to produce a dry powder;
heating the dry powder and flowing a gas over the dry powder to produce the coated cathode active material.

27. The method of claim 26, wherein the starting material comprises at least one of Li, Na, K, Ca, or Mg.

28. The method of claim 26, wherein the solvent comprises an alcohol or a hydrocarbon.

29. The electrochemical cell of claim 26, wherein the cathode active material particle comprises Li(NiₐCo_{b}Mn_{c})O₂, wherein 0<a<1, 0<b<1, 0<c<1, and a+b+c=1.

30. The method of claim 26, wherein the hydrogen-containing material comprises H₂O or H₂O₂.

31. The method of claim 26, wherein a ratio of the starting material to the solvent is from about 0.01 wt % to about 1 wt %.

32. The method of claim 26, wherein a weight ratio of the hydrogen-containing material to the starting material from 1:10 to 1:60.
